(19) United States
(12) Patent Application Publication
(10) Pub. No.: US 2024/0314242 A1
(43) Pub. Date: Sep. 19, 2024

(54) MULTI-USER INTERACTIVE PLATFORM APPLICATION

(71) Applicant: Faisal Ashfaq Satti Mohammad, Islamabad (PK)

(72) Inventor: Faisal Ashfaq Satti Mohammad, Islamabad (PK)

(21) Appl. No.: 18/258,334

(22) PCT Filed: Dec. 21, 2020
(86) PCT No.: PCT/RU2020/050387

§ 371 Date: Jun. 20, 2023

(51) Int. Cl. H04M 3/56; G06F 3/0484; H04L 12/18; H04L 65/1093; H04L 65/401; H04L 65/4038; H04M 3/42; H04M 3/58

(52) U.S. Cl. CPC H04M 3/565; G06F 3/0484; H04L 12/1818; H04L 12/1822; H04L 65/1093; H04L 65/4015; H04L 65/4038; H04M 3/42365; H04M 3/58; H04M 2201/42

(57) ABSTRACT

The claimed invention is a fully-fledged software application/platform, in which a user can: create a profile and add, edit, share and publish content such as programs, videos, articles, tasks, assignments, questions, lists of services, video streams, etc.; interact with other users by various means; create events; protect their content from unauthorized access and copying; and establish access control. The user can also gain access to content, for example a home page, a search page, various types of content and lists thereof, the profiles of other users, and other content posted by a user or other types of posted content, without entering the system, if access is permitted.

### CROSS-REFERENCE TO RELATED APPLICATIONS

This application is a national stage application of the Patent Cooperation Treaty (PCT) international application titled “Multi-User Interactive Platform Application”, international application number PCT/RU2020/050387, filed in the Russian Patent Office on Dec. 21, 2020. The specification of the above referenced patent application is incorporated herein by reference in its entirety.

### FIELD OF THE INVENTION

The invention is a multi-user based interactive platform application, where user can create his/her profile, Can Add, Edit, share and post content such as programs, videos, Articles, Tasks, Jobs, Questions, list services, video stream etc., Can interact with other users with various means, Can create event, Can secure his or her content from unauthorized access and copying, Can set controls of access.

### BACKGROUND

A technical solution is known for a foreign patent for invention no. WO2014139850 (priority date 14 Mar. 2013) “METHOD AND SYSTEM OF PRIVACY PRESERVING DURING A DEVICE TO DEVICE SOCIAL NETWORKING”. This technical solution is characterized by the fact that it refers to a way to preserve privacy in social networks between devices. The invention relates to a method that allows two social network applications inside two separate user devices that are in close proximity to peer-to-peer data exchange to find out whether they have a common user profile (for example, education, personal interests, biographical information, details), contacts, preferences, etc. and what user data they have in common, while maintaining the confidentiality of user data (for example, if they do not share any common user data, then the application should not know what information another application has).

A technical solution is known for a foreign patent for invention no. US2017353423 (priority date 18 Aug. 2017) “SYSTEMS AND METHODS FOR ENABLING DIALOG AMONGST DIFFERENT PARTICIPANT GROUPS WITH VARIABLE AND ASSOCIATION-BASED PRIVACY” This technical solution is characterized by the fact that it is a communication system through which people can enter into a dialogue with one or more participants in the dialogue. Different types of dialog can be presented to different persons based on the viewer's connection with the dialog and (or) on the basis of variable privacy settings associated with the dialog. Dialogues can be initiated as private conversations, with participants choosing whether to make the presentation of the conversation available to people who are not participants in the dialogue. Tools, such as editing tools, can be provided to dialog participants to control the availability of dialog content outside of dialog elements. A dialog display user interface can be provided to dialog participants, which includes a switch that allows participants to switch between open and closed dialog views, thereby highlighting differences in how the dialog is displayed to different audiences. Confidential information based on associations can also be implemented in online forums and in communities with limited access. Such privacy-aware systems can integrate to receive the content of a dialog with another messaging system and/or to disseminate ideas about privacy-aware dialogs in external systems, such as messaging platforms, social networks and search engines.

The technical solutions listed above have a number of disadvantages:
The technical solution of the patent of the invention No. WO2014139850 does not allow the user to independently choose whether to make its profile available or hidden to another user at any given moment in time;
The technical solution of the patent of the invention No. US2017353423 does not allow the user (participant of the dialogue) only in a unilateral manner, regardless of the command of the other user (participant of the dialogue), to make its communication with the given user (participant of the dialogue) hidden to persons who do not participate in this communication (dialog).

A technical solution is known in accordance with the international patent application Ser. No. US2019019208 (priority date 17 Jan. 2019), “CONSUMER DATA AND PRIVACY CONTROLS IN A SOCIAL NETWORKING ENVIRONMENT”. This technical solution is characterized in that it is a system in which participants of social networks monitor access and use of its data. The static information associated with the participant is obtained and the actions of the participant on the computer are recorded to generate dynamic information associated with participant. The participant obtains a set of participant preferences, including identifying a third party that a participant provides access to the participant's profile in exchange for compensation by the participant. The member profile consists of static information associated with a member, dynamic information associated with the member, and participant preferences. The participant profile is transmitted to the third party indicated in the participant settings, and the organization participant is provided with compensation for access to the participant's profile. The participant profile is stored in the block chain register and updated by writing each computer action to a record in the block chain register.

A technical solution is known under the international patent for invention no. US2018260543 (priority date 13 Sep. 2018) “AUTOMATED USER PROFILE GENERATION AND AUTHENTICATION”. This technical solution is characterized by the fact that it is a system and methods for automatically generating a user profile and authentication. One system includes a database that stores user profile data for multiple users, and an electronic processor that is communicatively connected to the database. The electronic processor is designed to receive from the computing device the first usage indicator for the first user and the first user ID for the first user and to generate a probable user profile based on the first usage indicator and the first user ID. The electronic processor is designed with the ability to extract a set of pre-generated user profiles from the database and determine a confidence indicator for each of the previously generated user profiles based on a probable user profile.

The above technical solutions have a number of disadvantages:

The technical solution of the patent for the invention No. US20190019208 allows only collecting statistical information on trust in the user profile without implementing a mechanism for limiting access to the profile;

The technical solution of US Pat. No. US2018260543 is intended to implement the authentication of a user profile using a very complex system (database, electronic processor), and also does not provide for a profile owner the ability to select the degree of restriction of access to its page in relation to the extent of trust to the rest of the users;

A technical solution is known for the international patent for invention no. U.S. Pat. No. 5,473,367 (priority date 30 Jun. 1993) “VIDEO VIEW SELECTION BY A CHAIRPERSON”. This technical solution is characterized by the fact that it allows one of the conference participants to assume the role of manually manipulating the contents of the video image, which will be visible to all participants (the so-called view of the chair). In addition, each participant is allowed to independently determine the content of the video image or choose the type of chair. These capabilities provide the reality of a virtual meeting room and allow other conference participants to free themselves from manipulating their own video image content. In addition, any of the conference participants can take on the role of determining the view of the chair, which allows you to control the shift of the angle of the view of the chair when changing the main speaker in a video conference.

A technical solution is known under the international patent for invention no. CN1072774 (priority date 20 Oct. 2017) “A METHOD FOR ASSESSING THE CONDITION OF A PARTICIPANT ON SPOT IN REAL TIME”. This technical solution is characterized by the fact that it provides a way to evaluate the effectiveness of the conference in real time by collecting a video or image of a conference participant, processing and analyzing the video or image and dynamically evaluating the conference in accordance with the relevant video or image content standard. The participants of the meeting see the effectiveness of the meeting, evaluate the attention of participants on the spot, the general and poor ratio in real time and the specific distribution of seats, statistics of information about the status of participants in real time, and also understand the main factors affecting the effectiveness of the meeting in real time, including sitting posture, bad phenomena, the location of staff, the number of staff etc. Provide the organizer or speaker with information about the status of participants in real time, which significantly improves the quality and efficiency of the meeting.

The above technical solutions have a number of disadvantages:

The technical solution of the patent for the invention No. CN1072774 is limited by the viewing of the state of participants only of the offline conference;

The technical solutions of U.S. Pat. No. 5,473,367, CN1072774 allow only observing conference participants, but not making it possible to take any measures to increase the engagement of participants into the work of the conference;

The technical solution of U.S. Pat. No. 5,473,367 is limited to manipulating a common video image available to all conference participants, which does not allow for an increase in the efficiency of engagement of particular conference participants.

A technical solution is known under the international patent for invention no. USRE43854 (priority date 11 Dec. 2012) “COPY CONTROL FOR A VIDEO SIGNAL WITH COPYRIGHT SIGNALS SUPERIMPOSED AS PREDETERMINED BITS IN THE VBID DATA OF THE VIDEO SIGNAL”. This technical solution is characterized by the fact that it is a method of copyright protection for video, in which the video signal is processed for selective permission of copying by superimposing in the part of the video signal that does not contain useful information about the image, an information signal about copyright indicating whether the visible image displayed from the video signal is an object of copyright rights and generation of a copy signal indicating the number of consecutive generations of copies that can be made from the video signal.

A technical solution is known in accordance with the International Patent of the Invention No. JP2000333141 (priority date 30 Nov. 2000). “COPYRIGHT PROTECTION METHOD AND DEVICE FOR HIGHLY PRECISE VIDEO SIGNAL, BROADCAST SYSTEM, RECEIVING DEVICE, RECORDING AND REPRODUCING METHOD AND DEVICE, AND REPRODUCING METHOD AND DEVICE”. This technical solution is characterized in that it makes it possible to reliably protect copyright by superimposing information obtained from the accompanying information added to high-precision video signals to protect copyright on transformed video signals as electronic watermark information.

However, the technical solutions listed above have a number of disadvantages:
Users viewing video content always have the opportunity to copy, distribute and otherwise infringe copyrights on video content, even if it contains watermarks, without the risk of further being identified as violators and bear appropriate responsibility for copyright infringement;

These solutions do not protect the authors of video content from its illegal copying and distribution on the Internet, that is, they have a low level of prevention of copyright infringement.

The technical solution of the International Patent of the Invention No. TW201441993 (priority date 1 Nov. 2014 g) “NETWORK TEACHING RESOURCE INTERACTION SYSTEM”. This technical solution is characterized by the fact that it provides a system of interaction of network resources of training. On the system side, at least one server of the server is pre-loaded with a database of participants, a database of training materials, a control module and a support interface. The activation interface is at least embedded with a training option, a training option, a channel option, a creation option, and a group option. The user may use the user of the end connection device to connect to the host server via the Internet, and may enter the capability interface to include the training, teaching, educational materials publication, creation and group discussion provided by the system according to the user access right. Therefore, the present invention facilitates quick access to educational materials and knowledge over the Internet and integrates the content of educational materials and knowledge in notes or training resources intended for group training.

However, this technical solution has a number of disadvantages:

This interaction network does not include a person in the system of interaction, which performs training, therefore, this interaction system does not provide adequate interaction of participants and distribution of educational material and programs, based on the role of each participant;

In this interaction network, the participant does not represent the full picture of the training programs and does not have the right of their selection, which significantly limits the level of interaction of the participants.

A technical solution is known under the international patent for invention no. US2017257333 (priority date 7 Sep. 2017) “PREVENTING MESSAGES FROM BEING SENT USING INAPPROPRIATE COMMUNICATION ACCOUNTS”. This technical solution is characterized by the fact that it is a method, system and computer program product for preventing messages from being sent using inappropriate communication accounts. A message created by a user of a mobile device is analyzed to identify the topic and sentiment. The appropriateness of the message being sent to the intended recipient(s) using a selected communication account (e.g., company social media account) is determined based on one or more factors, including the analysis of the message to identify the topic and sentiment. A score is generated as to the appropriateness of sending the message to the intended recipient(s) based on such an analysis. If the score is less than a threshold value, then the message is deemed to not be appropriate to be sent to the intended recipients using the selected communication account. In this manner, potentially erroneous communications, such as accidentally posting a message to a wrong social media account, may be prevented.

It is also known from the general state of the art that the called subscriber may or may not receive incoming audio and video calls, hang up and otherwise interrupt an incoming call. Also, from the general state of the art, it is known, for example, such a technical solution as “Yandex Telephony”, in which there is a call moderation function. The essence of this solution is that the subscriber can decide whether to pick up the phone, reset the call or switch the call to voicemail (“Call moderation” [Electronic resource]//The Yandex Help website.-URL: https://yandex.ru/support/telephony/settings/moderation.html (accessed 21.06.2019).

Also, from the general state of the art, various technical solutions are known in the field of protection against unauthorized recording of incoming calls without the knowledge of the called subscriber. For example, a technical solution is known in the form of a free application “Signal” for the IOS system, the essence of which is that It provides cryptographic protection of telephone conversations—protection against wiretapping, recording and interception. For encryption the program uses the AES algorithm with a 256-bit key and the corresponding integrity checks. The developer promises reliable and clear voice communication without interference and loss of fragments. The Signal application is able to provide voice encryption throughout the signal path. To do this, use a Wi-Fi connection or a mobile connection. Confirmation of protection against wiretapping is implemented by displaying on the screen two random words that the interlocutor must repeat (“The free Signal application will protect a telephone conversation from wiretapping, recording and interception” [Electronic resource]//MACDIGGER website. —URL: https://www.macdigger.ru/news/post/besplatnoe-prilozhenie-signal-zashhitit-telefonnyi-razgovor-ot-proslushki-zapisi-i-perexyata (accessed 23.06.2019).

The technical solutions listed above have a number of disadvantages:
technical solutions that allow the subscriber to choose, accept or reject an incoming call, transfer the call to voicemail, do not provide the subscriber with protection from the actual conversation itself, in which the interlocutor can insult, humiliate, otherwise defame the subscriber or waste his time on empty conversations; that is, the subscriber in any case sooner or later he will accept the call and the interlocutor can tell him anything and record the conversation;
technical solutions in the field of protecting incoming calls from being recorded, for example, the “Signal” application for the IOS system, allows you to encrypt an incoming call and make it unavailable for recording, but their main drawback is that, firstly, this call, even if it is encrypted, can still be recorded and then reproduced by an unscrupulous interlocutor using special programs; secondly, in the case of direct recording and playback of a call in real time by an unscrupulous interlocutor (for example, audio broadcast of a conversation on a social network, live), protection from recording a conversation will not save the subscriber from insults and humiliations.

### BRIEF DESCRIPTION OF THE DRAWINGS

### Detailed Description of the Invention

The claimed invention, unlike all of the above solutions, is a full-fledged software application platform in which the user can create his/her profile, add, edit, share and publish content, such as programs, videos, articles, tasks, assignments, questions, list of services, a video stream, etc., can interact with other users by various means, can create events, can protect its content from unauthorized access and copying, can establish access control. The user can also access content without logging in, for example, the home page, the search page, various types of content and their lists, profiles of other users, other user-posted content or other hosted content type, if access is allowed.

The term “user” is used to reference the Platform account owner, such as an individual, consumer, group, closed user group, user-agent, Automated agent, corporate or a commercial entity or any authorized person or entity.

The system may include software designed for collecting and disseminating this information on various media devices, i.e. mobile phones, digital cameras, digital recorders, laptops, personal computers, body gear, ocular viewers, consoles, terminals, tablets, drones and any Internet-ready device.

The platform is comprised of a graphical user interface designed specifically for viewing on mobile and non-mobile computing devices, i.e., mobile phones, laptops, personal computers, body gear, ocular viewers, drones, PDAs, consoles, terminals and tablets. It may also include a full, and always updating, commercial relational database engine for the storage of content and user inputted information and user-defined custom preferences and locations.

The platform may include annotation and indexing mechanisms which may simplify the collection, storage and management of critical activity data elements and uploaded objects, bring these user-defined items into the same searchable context as those that are inherently systemic and structured so that they may be indexed and matched for tracking, analyzing and disseminating results in a useful way-through mapping, calendaring, notifying, viewing, reporting, archiving and sharing.

The platform may have a universal browser-based presentation structure that may be scaled and deployed across various hardware resources and networks without a need to retool. It may be implemented on phones, laptops, tablets, optical viewers, body gear, drones, PDAs, consoles, terminals and personal computers by rendering the Software at the non-mobile or mobile computing device level.

In the proposed application User can create profile, can login, and can sign up, but User may also access content without login, Like, Home Page, Search Page, Different content Types and their listings, other users Profiles, Other user posted content or other posted content type if access allowed.

The compilation of the homepage content type will be anonymous, where the user can view the homepage data without any direct connection to the content or the content creator. It is most preferable that the home page has the following lists of content types with possible additions in the future:
Upcoming Live, Top Lives
Top Profiles
Top Videos
Top Articles
Top Questions

Data related to these types of content will be displayed through the application backend and frontend based, on special criteria based, and on some system managed algorithm and weightages that will work for global application data or region-specific local data stored in the database. Criteria can be defined, redefined, edited, or controlled through the application Admin Panel or by the application administrator. Possible proposed criteria or algorithm for different content types are as follows,

Home page Upcoming Live, These are futures events listed in order those are preferably nearest to farthest from current time and on the basis of future time of their actual happening with combination of weight age calculated,

Following are the attributes associated with upcoming live those will be assigned different weight age values,

Content category of upcoming live event, Upcoming live event Views, Upcoming live Event likes, Comments on Upcoming live event.

For example From Application Admin controls, Upcoming live event has been assigned with the following weight age values,
View=1, Like=1, Comment=1 category 1=1 category 2=1

And system is set to update upcoming live list every two hours for the events going to happen in next 24 hours,

Now there are only two upcoming live events in next 24 hours with following data and attributes
Event A Category 1=1, Views=10 likes=5 comments=2 Total Weight=18
Event B Category 1=1, Views=12 likes=3 Comments=4 Total Weight=20

Event B will be shown on the top of the list of Upcoming live

Further another weight age may be added where event created with less time duration will have high weight age as compare to old event. Less time duration means One event was created 10 days ago and one is created today, Both events attribute would not have equal weight as because of Time difference both events comparison is distorted,

Another way to handle this is to consider add in the data or attributes of event for specific period like list upcoming event every two hours, with last 4 hours data or attributes (views, likes, comments etc.) added for the events going to happen in next 24 hours

Home page top lives is a combination of both current lives and recent Top lives,

The list will be compiled on real time basis when any attribute related to the Top live event is changed,

The attribute that will be assigned weight to top live event is
Total views during live event
Total likes during live event
The category of live event

When there is no current live event the recent top lives will take place in the top lives list

Home page Top Profiles, list preferably be compiled on the basis

Profile followings+Profile Content contributed+content contributed likes, views, comments, shares or actions performed by other users.

Home page Top Videos list, Top videos list preferably will be compiled on the basis of videos with highest to lowest weight age for specified time period.

Video weight age is associated with following video attributes, Video category, Video like dislike, Video views, comment on videos.

Home page Top Articles, Top Articles list preferably will be compiled on the basis of Articles with highest to lowest weight for specified time period.

Articles weight is associated with following articles attributes, Articles category, Articles like dislike, Articles views, and comment on Articles.

Home page Top Questions, Top Questions list will be compiled on the basis of Questions with highest to lowest weight age for specified time period.

Questions weight age is associated with following Questions attributes, Questions category, Questions like dislike, Questions views, and comment on Questions.

In future, home may have a side panel by the categories that may lead direct search to profiles those are related to that specific category with additional filters associated.

In proposed application, at the time of signup user can mention the profile type

Like, is the profile type is for individual person or for institution or organization,

If institution or organization is selected the Display name of profile must be unique and Institution name taken may not be assigned to individual user as well.

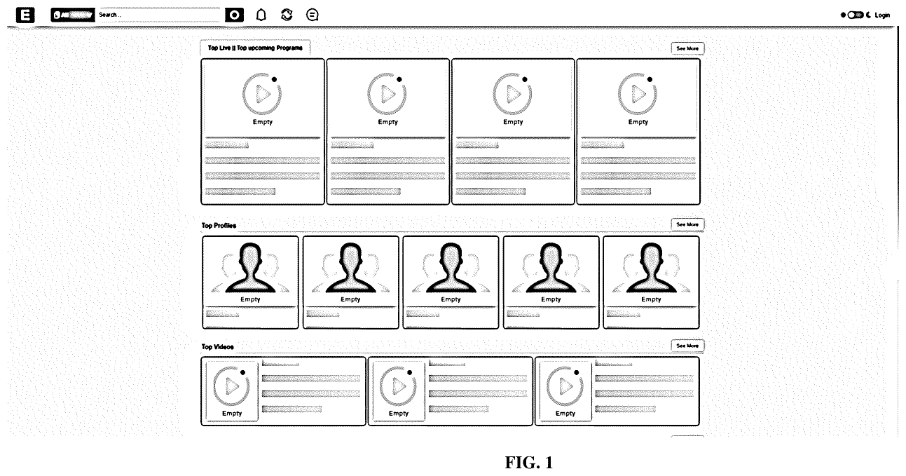

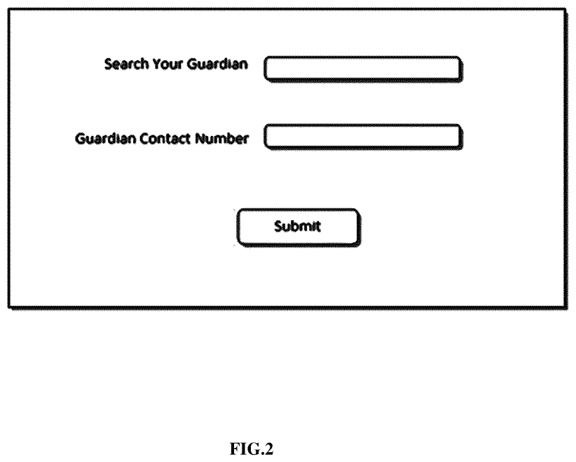

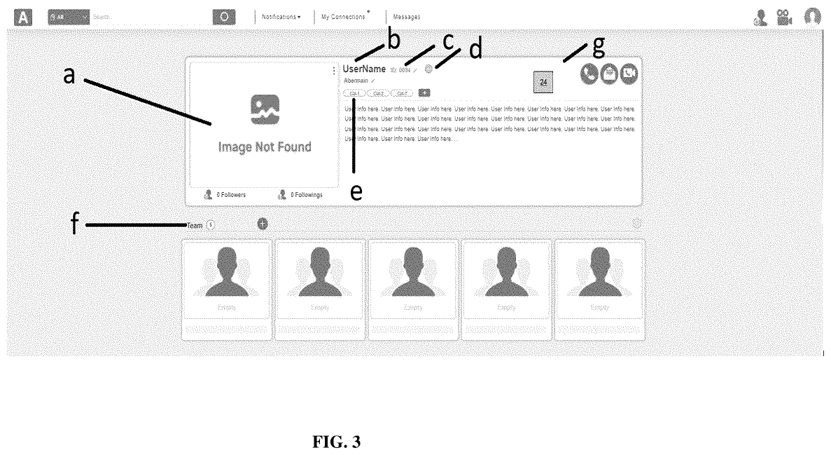

When institution or organization is selected as profile type the services and function will be different as per normal profile,

Where a Panel will appear where a team member or person belonging to institution can be added and displayed as per display policy is set, shown in FIG. 3,

Team member may be added by sending request or by receiving and accepting request.

In this application Profile managers or profile admin can be added or associated by actual owner on request or by direct grant of access, which can be edited later, on granting access the owner may limit the access to some functions or limited access or module based access.

In this proposed Application user can create his/her profile and if user is underage and is not allowed to use application without his/her guardian or parents' permission, after sign up to application for application access, he/she need to send grant access permission request to his/her guardian who is already the application user and has allowed receiving guardian grant permission request from other users,

For avoiding spamming of guardian permission request, the permission seeker may be required to add guardian Profile Name or associated profile identifiable attribute with user contact number to whom he/she is seeking permission, the contact number that is stored in application database but is not publically displayed.

The request preferably may only be sent to human entity related profile.

FIG. 3 shows following User Profile Information:
a) User introduction video section
b) Profile title
c) System generated unique ID
d) Profile verification status
e) User category or profession
f) Team Members
g) Enroller or Appointment Calendar

In this application user may be required to get his/her profile verified to access some services or optionally can verified his/her profile. The verification may be from simple to advance type,

Simple verification may be: email verification or Phone number verification

And Advance verification may be: Physical/onsite verification or passport or other official ID based verification.

In this application user will select the category he/she belong to and on the selection of categories the Profile template appears as accordingly.

In this application user can belong to different categories type and can have different service and functions on his/her profile as per category requirement;

When user creates the profile a unique code to every profile is assigned to user:

This unique code will have following benefit
Direct user identification and search through that unique code in application
Profile identity theft discouragement: user can use the same unique code and use it in his/her profile introduction video through that code in audio or in display.
User can allow this code to be printed on his or her content to avoid content copying like images or other visual type
Unique code can be used as incoming call number, Where this code can be entered after call is made to universal number that will forward call to user to his/her provided contact number, Or
Directly this unique code can be dialed along with provided universal number/s of application.
Hence this unique code will work as user identity and further services linked to that unique Id

Now user can have calling function One to one, to, many to many and will have extensive controls that who can call, inbox and can access user content

Incoming calls, User can control who can call user, in which user can select, only verified user can call user, now in verified user type user can even select the type of verification simple to advance:
Simple e-mail verification type
Mobile number verification type
Government ID based verification type
Other legal documents based verification type
On site or physical verification type

Now user can control and define further criteria to system and application who are allowed to call, like the gender, age, location etc. System will not forward call of the one who does not meet criteria or may inform the caller the reason of call failure, so the caller can make improvements to meet the criteria.

Incoming call management, In this application user can configure and assign any other person or persons for call forwarding in case user is already busy or not available, caller can see in advance the list of those who the call Is going to be forwarded or system may provide an option to select who the call should be forwarded, where caller can select which forwarder the caller wants to speak or who the call is to be forwarded and caller can decide within certain time limit or with no limit to proceed or to cancel the call.

If user is not available caller may have option of to be notified, which if opted, then caller will receive notification of when user is available to be called.

Video Audio call moderation function of an application is wherein, User can assign moderator/s for incoming audio video call, In case of moderation feature is activated, enabled or applied by the User the caller may be notified that the call is being moderated by human or by machine,

In machine based moderation system may drop audio call or audio phrase of video call with those videos frames that is prohibited and system decides inappropriate, through already prohibited words audio list fed to the system by application admin or by User himself and through auto recognition function.

In machine based video moderation, system may cancel video call or video frames that are prohibited and system decides inappropriate, system may be trained on this through machine learning and image processing.

In this proposed application, when a call is made, User may allow or disallow audio video call recording to caller vice versa,

A caller or User may be notified in advance that you are not allowed or prohibited to record audio video call by any means, if user is allowed to record audio video call, system may allow feature of recording and storing of any such conversation.

To avoid user from Capturing the video call, application may require users to download application, plug-in, programs those do not allow screen capturing or recording while application call function in use,

Further caller and User may enable antitheft or piracy function, that displays user's identifiable information on display area with changing places and shapes frequently.

Caller call cue function is a function in proposed application wherein, When User is an important person and has multiple callers calling at once, A caller called User and user is busy on another call,

Caller has option to further continue by opting to keeping himself in queue of callers.

If caller wants to continue caller can opt to go for auto dialing function, in which system can assign a queue number to the caller which preferably will be a sequential number or A countdown number,

In countdown most preferably when number 0 is reached this means it is caller turn now and call is auto dialed by system and then answered by the User.

Auto dialing function will keep caller in queue and when caller number reaches it will auto dial the call, when auto dial function is selected system may keep informing the current number in progress most preferably displayed on screen of the waiting caller device or application. The system may also let caller know the estimated time to wait and remain when caller turn expected to come, this Queue number may be the reverse count down, If caller turn in queue is far, caller may opt for notification based intimation, So instead of keeping stick with the application caller can carry out other tasks, The user may guide a system, that to send notification before set estimated time before caller call is going to be dialed or may select a notification generation when certain queue number before number assigned to caller is reached and any other similar notification. Now the recommended method of keeping caller up to date with current queue status preferably visual with audio announcement, visual is preferred over audio as announcement only on Audio means keeping continuously intact with audio device which is cumbersome

If there is some privileged calling criteria is set by User in system application, Caller will have option of priority calling rather waiting in queue if the caller is privileged caller and meets the criteria of privileged caller then caller will have priority on others those do not meet the privileged criteria set by User in system. User may have option to set incoming calls auto termination time, for example User set limit of call maximum to 5 minutes, Every incoming call will automatically terminate after 5 minutes, Which may or may not be notified to caller in advance during or end of call.

In this application Caller will have option of Pool calling, Pool calling is the incoming call with one recipient and multiple callers at once, Once means all in one session,

Pool calling may be planned or unplanned,

When pool calling is unplanned caller may add other participant that may require user permission who call is being made,

In planed pool calling, caller can create a pool calling event with future date and time of call with adding other callers and User who is to be called that can be accepted or rejected by other callers and User if they want,

If there is any criteria set by User for such incoming call, callers must meet that criterion to create such pool calling event that includes the User, who is going to be called,

A User may receive a request for this pool calling event scheduled to have incoming call to user which may be accepted, rejected or No action made by User Who call is to be made, System may auto cancel request if not responded by User within some specific time period,

If accepted system may auto dial call at the set event time,

A caller may edit or delete such calling event subject to policy defined and accepted by User who is going to be called; System may send user an updated request for acceptance, rejection or no action.

In this application user can have inbox type of communication where user can receive messages and can reply back. Here user can control who can send the message can define criteria which sender must meet to send message to user, if criteria is set by the user, system may define the reason to sender for which user is currently not able to send message with reason of failure. Chat can be of group chat, System can auto translate chat subject to user langue preferences

For inbox or chat user can further define that Only verified profiled type user can inbox or send message to user and even can mention the type or level of verification, means, Only user can inbox with Advance profile verification, means document based verification or on site/physical verification and similar etc.

The inbox will have fav or message book marking function which will book mark and fav user messages/all listed under Fav message when fav messaged tapped it will take to specifically part of that inbox messages

Here user receiver and sender may have option to lock the conversation which needs password or other secret key to open or access that conversation

Proposed application may have Identity less chat and inbox on real time functionality, where user or users can enter into identity less chat when online,

That will remove any name image or identity of users in conversation Interface from application view when that mode is activated or started,

Preferably that invisible identity less chat will vanish once conversation ended instead of stored at users end

This Identity less chat can be initiated during the chat session or before the chat session started,

This session may require consent of all participants to initiate the session.

When identity less chat is initiated system may assign dummy identities to users to keep their conversation track.

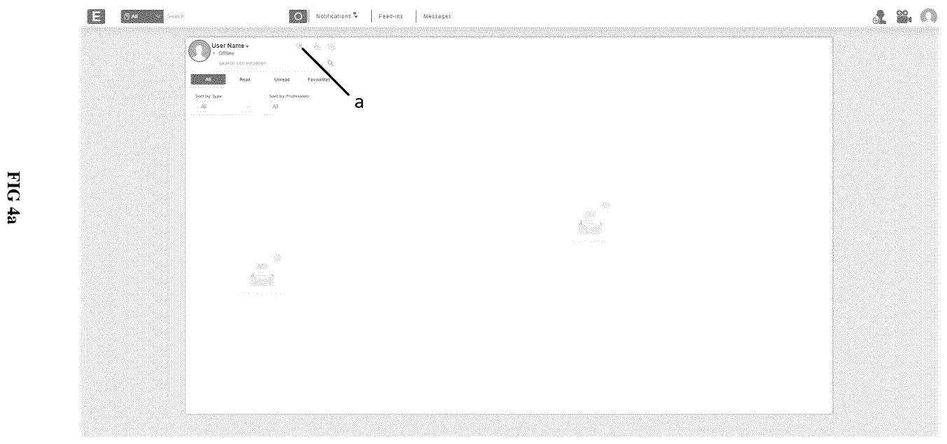

In proposed application user may be able to use hidden chat function, Hidden chat is a function where user can hide his/her whole conversation, which will be removed from main chat list and will be listed in hidden chat list, Now when new message related to hidden chat appears the chat will remain there and will not be displayed in main unhidden chat list, but the hidden chat icon will indicate user that there is new message related to hidden chat, so user can see that chat in timely manner. FIG. 4a and FIG. 4b. Shows hidden unhidden chat function, In this figure eye icon shows that un hidden chat list is selected and displayed on hover an chat hidden icon will be displayed that on click will load hidden conversation list

In proposed application user will be able to do multiuser or group based chat, If Multiuser chat or Inbox is created, Owner or owner assignee of multiuser chat can moderate the messages and can enable publish permission function, which may require owner or owner assignee of chat or moderator permission before publishing of such message, Owner or authorized moderator may be able to unpublished or delete the published message also.

In proposed application there will be broadcast chat, Broadcast chat is chat that is broadcasted where those who are not part of chat can see the chat conversation if allowed, the purpose of these type of chat is to facilitate live audio/video broadcast,

Here the one who is broadcaster or his/her authorized or assigned person can enable disable chat, can control who can do chat and can further activate preview based moderation function.

In preview based moderation function the broadcast chat is not published unless is not approved by the moderator of Broadcast which may be a human or machine based, if human, a Broadcaster can assign moderator or moderators of chat at the time of event creation of broadcast, where request is sent to potential moderator/s to accept moderation task, Where request receiver may accept or decline that request to be a moderator,

If accepted then at the time of broadcast only broadcaster and assigned moderator will receive chat first that is unpublished which they can allow to be published or reject to remove from the queue of other chat,

Here moderator or broadcaster can tag some chatter as direct publish, in which system will publish chat directly for those who are tagged or allowed direct published for current session or for future and tagged allowed can be untagged.

Participants may be allowed to attach file, and broadcaster or moderator or any of assigned person may allow or disallow the file type or any of attachment

Broadcaster or moderator or any of assigned person may control file download ability on other participants or may only is downloaded or if media type file played on broadcaster to be viewed by others.

In this internet based application user can create connect package and can define this in application the criteria where he/she can allow other users those meeting the required criteria to do that specific number of messages and can do that specific number of calling video/audio with user.

This package created may be:
Time bound
Redeemable non-redeemable
Cancelable non-cancelable
Refundable or non-refundable
Partial usage partial refund or no refund

The package may be of inbox only based or inbox must reply based

Only audio, video, inbox based or combination of all,

Package can be time bound or can be transferable. Package can be only inbox base or is reply based, Package may be cancelled from both User A or B or may be consumed or refunded as per policy defined. Policy change may be for future contract not effective for pervious may be effective on already existing contract.

Like other functions in this proposed application user can create Program that is upcoming live broadcast or conference which may be a
A single event based program
Multiple event based Program
Recurring type Programs
Non recurring type programs
Scheduling live program Detailed:

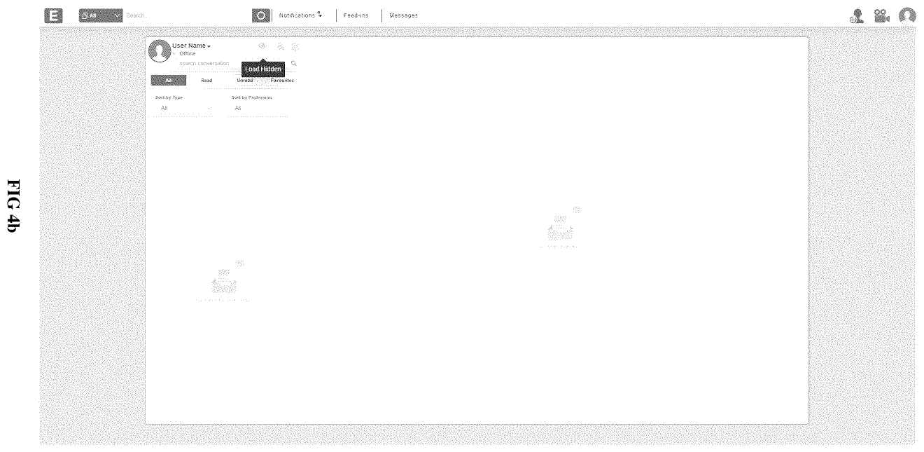

User A, Which may be a profile Owner, Admin, sub-admin, Associate, performer or any authorized person may create/schedule live broadcast. Users A may sign in or sign-up to application to schedule live broadcast. User B is any person or entity, who wishes to join view or access live broadcast at any stage or any of its related information or service. User B may sign in or sing-up to access or join scheduled live broadcast. Scheduled Live broadcast may be of any type, upcoming live stream, video audio stream, upcoming live program, One time, recurring, single, multiple, grouped, parent-child, Peer-peer, upcoming Broadcast, upcoming conference etc. A scheduled live broadcast may have different stages and may have different User interfaces like Upcoming Scheduled live broadcast, current scheduled live broadcast, past scheduled live broadcast. User B may be able to share or embed scheduled live broadcast to other platform domains and applications if allowed by User A through access level settings. Different interfaces may have different information and functions for different user's types. As shown in FIG. 5, 6,7,8,9. FIG. 5, 6,7,8,9 is just for reference real Interfaces may differ in styling but may have most of functions as mentioned.

For simplicity, common known functions or operations are not defined, such as login, registration, following, following request, messaging, notification operations, viewing the list of scheduled live broadcasts, confirmation model and overlay, search-related functions and operations, input form fields, general privacy settings, etc.

FIG. 5 shows the combination of both User A and User B upcoming Scheduled live broadcast Card or thumbnail interface, In reality both User Types interfaces may differ as per their rights, For example Edit/delete/settings function will be available to User A only, Report send request function will be available to user B only.
(110) Shows number Grouped or multiple Scheduled Live broadcasts
(108) where user may able to view information related to scheduled live broadcast but still need to send request for approval to User A

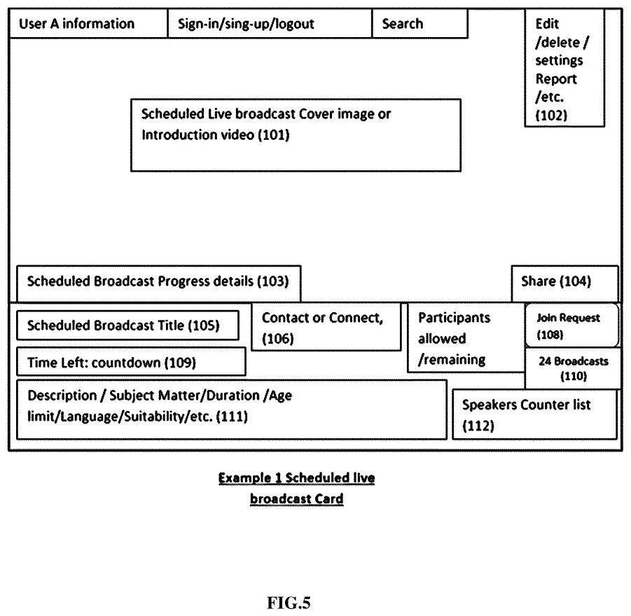

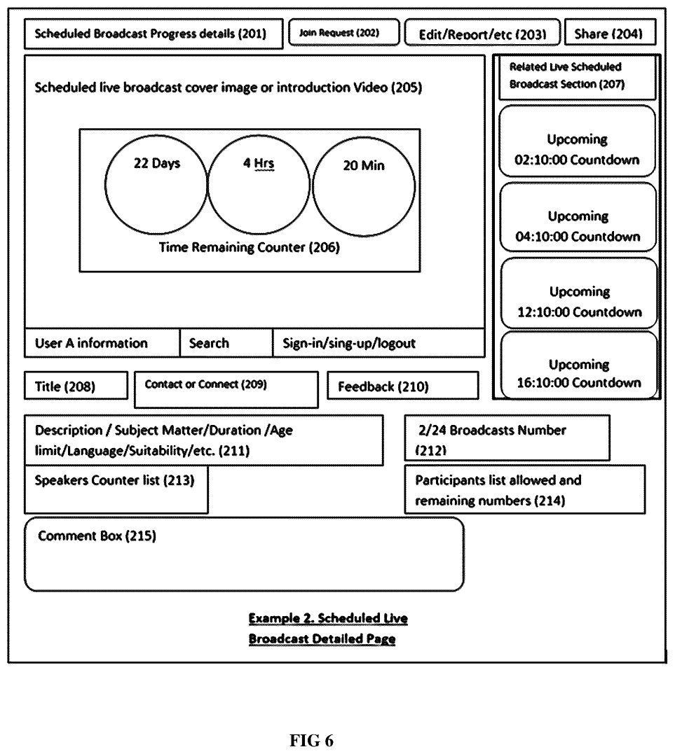

FIG. 6 shows the upcoming Scheduled live broadcast detailed page user interface.
(207) related live scheduled Broadcast section may show User A other scheduled broadcasts and or Similar broadcasts on the basis of subject matter and system suggestion etc.

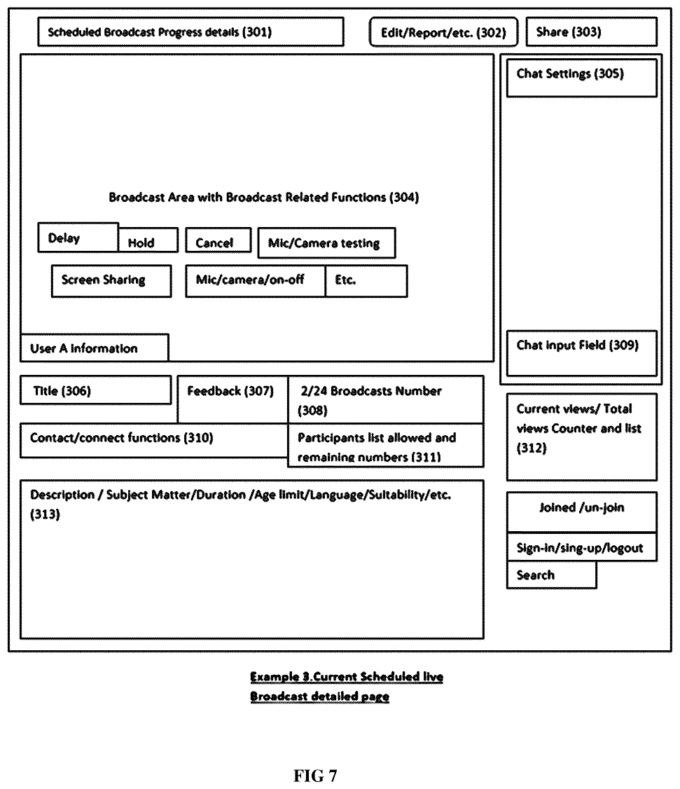

FIG. 7 shows the Current Scheduled live broadcast detailed page user interface.

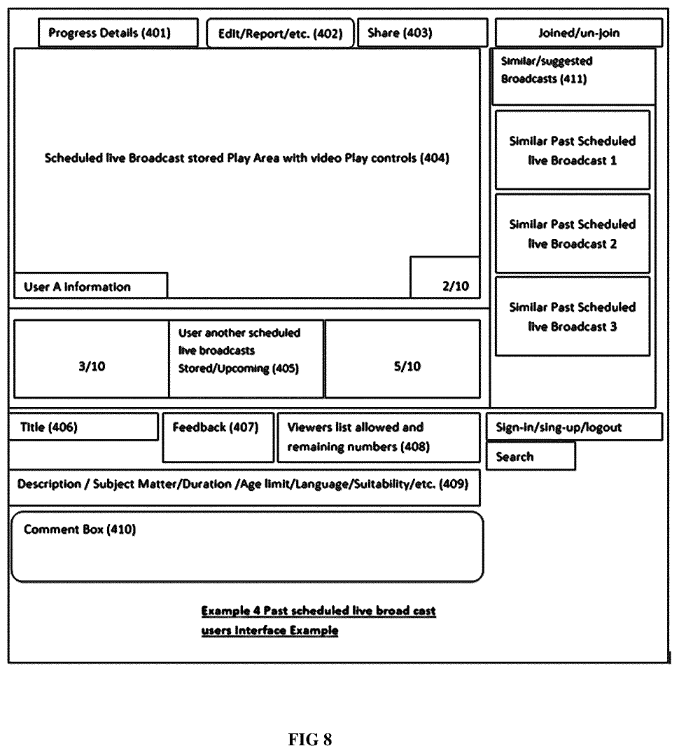

FIG. 8 shows the Past Scheduled live broadcast detailed page user interface.

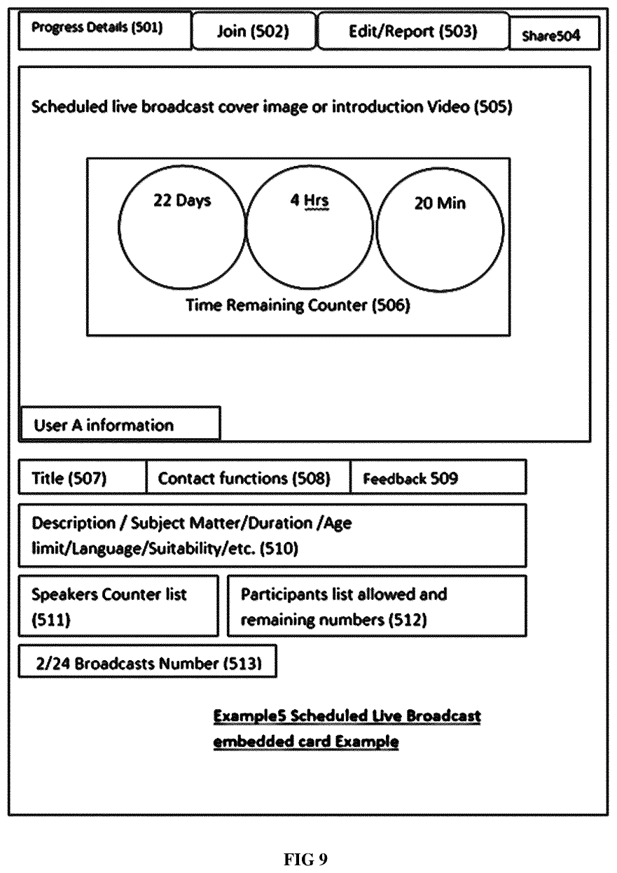

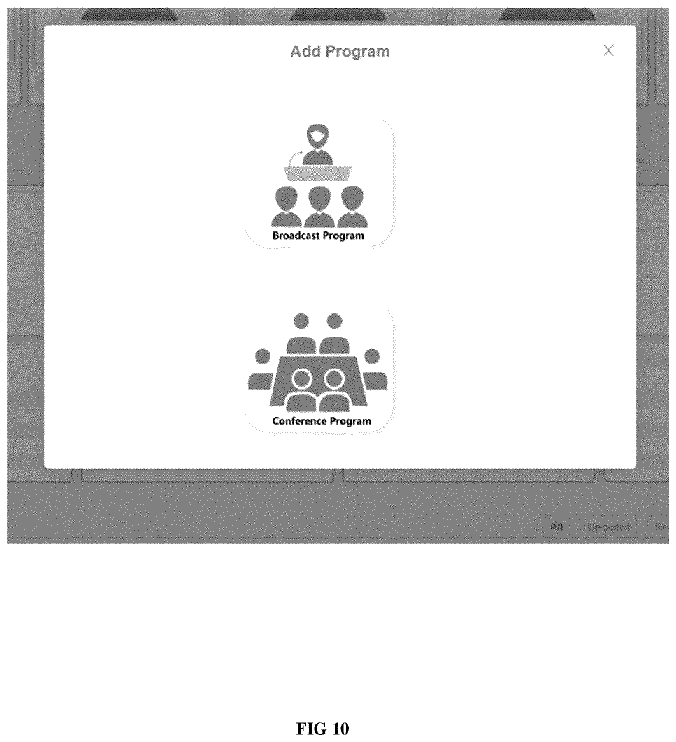

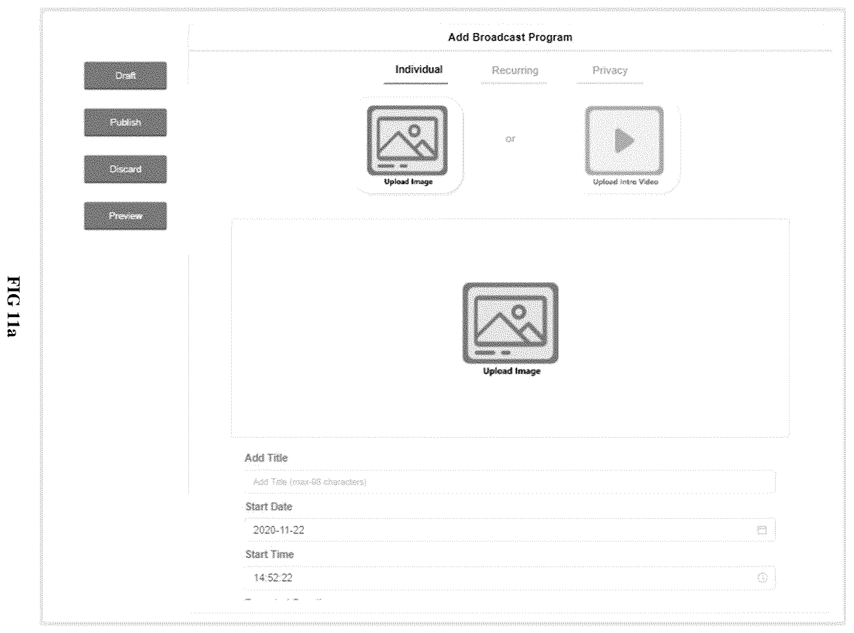

FIG. 9 shows the upcoming Scheduled live broadcast Embedded, shared Card to other applications and domains.

User A may enter live broadcast related information while scheduling live broadcast, User A may be able to edit/delete this information before, during, or after broadcast happened. Our proposed Broadcast schedule system may be an independent or dependent system, a complete application or part of an application, represents a single or part of single interactive social platform, and may consist of any suitable front end, backend or any other system development technologies. Broadcast schedule system may include software designed for collecting and distribution of information on various media and computable devices.

While scheduling broadcast User A may define, Who can see upcoming broadcast related information or announcement, For example User A has Scheduled Broadcast and allowed Group Z only to view upcoming broadcast related information or announcement, Now Group Z user may only see limited Scheduled Broadcast information or announcement Interface (Interfaces shown as in FIG. 5, FIG. 6, FIG. 9). However still Group Z users may not be able to participate access live broadcast or its interfaces (interface shown as FIG. 7, FIG. 8) unless Group Z User B do not send request to join and ask permission to join to User A and subsequently access is granted by User A to User B, if request to join for scheduled live broadcast is required and function is enabled by user A. User B may able to view scheduled live broadcast without login or sign up to application, If User A has allowed everyone to view scheduled live broadcast and no permission to access is required, But User B may not be able to contribute, comment, react, response, without login to application. User A may enable/disable Scheduled broadcast join request function, whether User B may join or access Scheduled Broadcast directly or on request where permission to access is sent by User B to User A for approval. If User A sets scheduled live broadcast access level to join on request or User B needs to have User A prior permission to view or participate scheduled live broadcast, User B may send request to join Scheduled live broadcast to user A who may Accept/reject/or take no action. System may maintain list of requests with actions, at any stage of scheduled live broadcast. User A may receive scheduled live broadcast Access request at any stage of scheduled live broadcast. User A may accept reject request to access at any stage of scheduled live broadcast. User A may define editable criteria for scheduled live broadcast request to access to system for filtering and forwarding request to access for manual approval or for automatic system based approval, rejection or no action. A system may maintain scheduled live Broadcast list accessible to user B like, Access granted, request pending, request to join approved upcoming scheduled Broadcast, Request to join approved live scheduled Broadcast, request to join approved past scheduled live broadcast. An approved joining request related to scheduled live broadcast may be notified to user B and a rejected request may also be notified with the reason of rejection. User B may send scheduled live broadcast access request to User A online through platform or offline, an offline request is where User A may add User B manually in access granted list. User A may allow or disallow other users or specific users to view scheduled live broadcast Access request received and approved participants list. User A may grant access to User B after request to join received and approved by User A, to scheduled live broadcast with different privileges, For example few allowed chatting and few may be allowed only view, different stream qualities etc. A system may automatically revoke access previously granted for scheduled live Broadcast to user B at any stage of scheduled live broadcast, where user B has failed to maintain standard at any time as per standard defined by User A after access was granted; this may be done manually by User A or automatically by system on the basis of standard set by User A. Before revoking system may intimate User B the standard User B is failing for improvement to avoid revocation. A previous Scheduled live broadcast may be stored and are accessible to those who were already granted access and new request to access Users after approval.

Related to live scheduled broadcast notifications, not every application user will receive these notifications, only User B those are connected to User A or User B those have joined user A scheduled live broadcast or users B those are connected to user B those are connected to user A may receive notifications if User B has allowed any such incoming notifications in application. A system may maintain user “A” scheduled broadcast list accessible to User “A”, and system may remind User “A” time by time through notifications, e-mail, mobile texts, voice messages etc. about User “A” upcoming live broadcast as reminder to user “A” to ensure appearance as scheduled.

If User B is allowed to View User A scheduled live broadcast upcoming Interface (Interfaces example shown in FIG. 5, 6, 9) and User B is allowed to send request to join Scheduled live Broadcast, after getting approval to join from User A manually or automatically, A system may keep record of absence of User A and User B both, If anyone of them did not appear at Current live Broadcast phase (interface example FIG. 7), when scheduled broadcast actual begins, as scheduled and agreed, Later this record may be accessible to any user type or for any user based or system based action, evaluation and decision etc.

Scheduled live Broadcast may start automatically as per User A scheduled time, After auto start system may confirm presenter is present if not confirmed may stop, cancel or hold the broadcast, Before automatic start user A may chose option to delay automatic broadcast start temporarily, for example Delay by 5 minute, Delay by 10 minutes. User A may enter reason of delay and save which will appear at User B Interfaces in real time or with minimal delay. So User B may keep intact and updated. System may cancel Scheduled live broadcast automatically with or without delay if User A may failed to appear at scheduled time or without any action performed by user A like, delay, hold, start, etc. with or without notifying User A in advance or later. An automatic cancelled scheduled live broadcast may be notified to User B, the participants, and system may keep record of it for any user based or system based action, evaluation and decision etc.

User A and B may be able to see scheduled live broadcast Progress about live broadcasts, which will be in the future, will start next week, are at the initial stage or at the completion stage for example if there are group of 10 live broadcasts system may show progress that 8 are upcoming 1 is past and one currently in progress or 40% completed and 60% remaining with a countdown method for upcoming scheduled live broadcast etc.

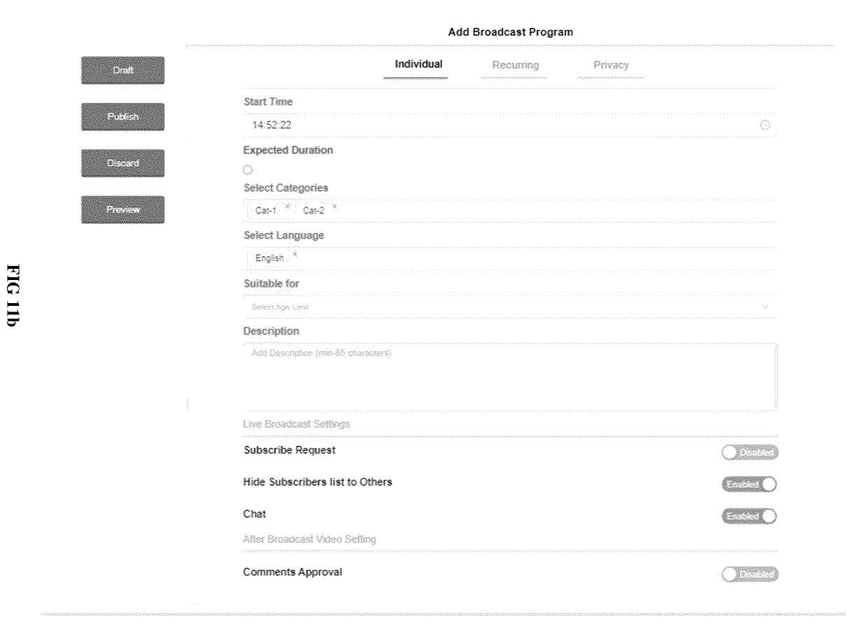

FIG. 11a and FIG. 11b shows interface form for scheduling broadcast program,

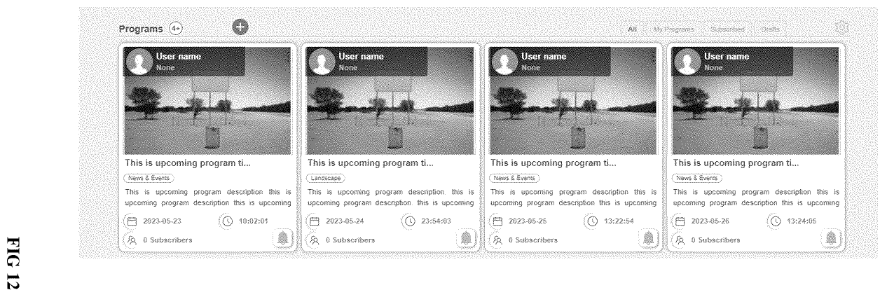

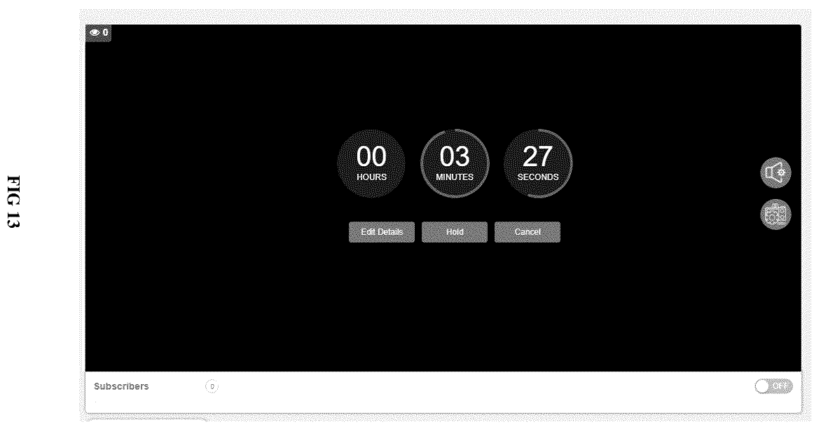

FIG. 12 shows User Added and Published Program Card on User Self View profile Panel

FIG. 12 shows subscribe Icon on self-view program card that indicates that subscription without request is allowed.

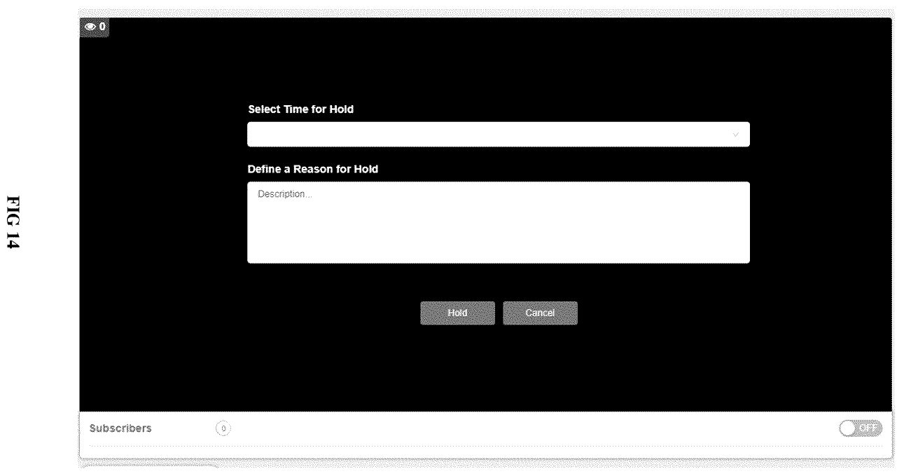

FIG. 13 shows Program to start Presenter View

FIG. 13 is the view that will be accessible to presenter when program is going to be live in near future like within 5 minutes, 1 hr. or 2 hrs etc.

Presenter will have Program Auto Start delay or hold option,

Ideally the set program will start automatically at planned time but if presenter is not ready can hold and delay program with different time delays option like delay for 5,10.15 minutes etc. shown in FIG. 14, and can add message that will be shown on viewer side at real time or with minimal time delay.

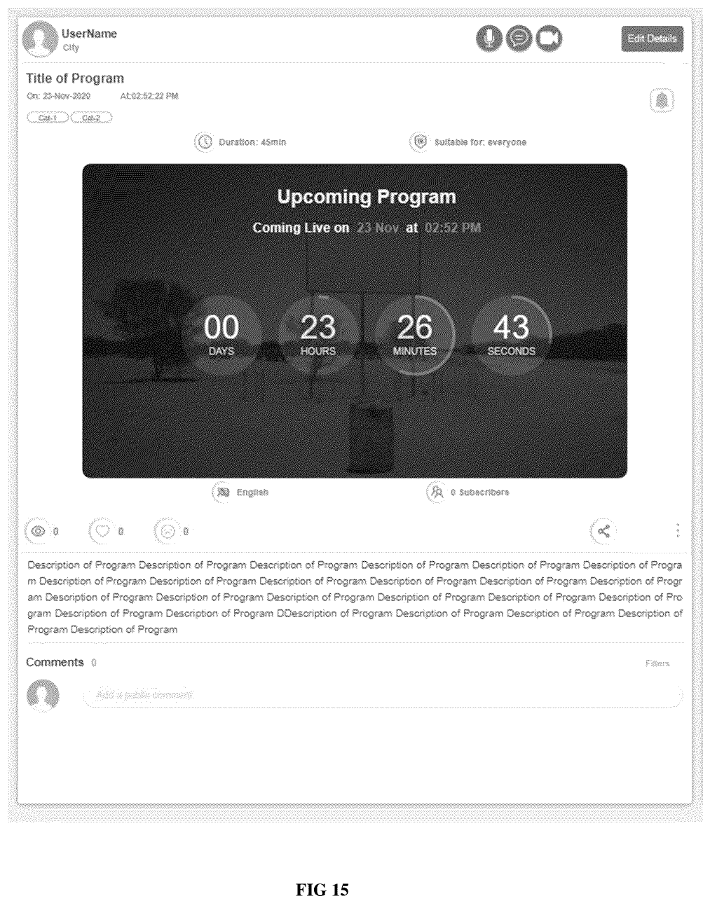

FIG. 15 shows New Program Start Detailed Self View for Distant Programs

When Program is not in near future this view may be displayed to presenter. In presenter view presenter can go to edit, other icons, Subscriber and contact icon shows the presenter the state of those functions like, Audio video call is enabled and subscribe type status etc.

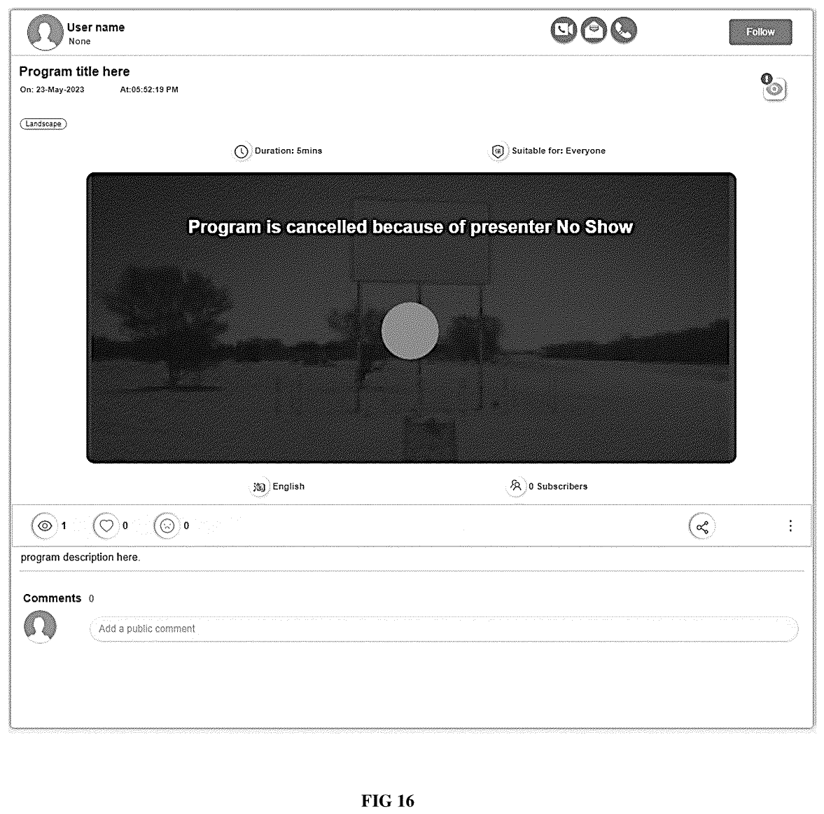

FIG. 16 shows Program detailed page that has been automatically cancelled because of Presenter nonappearance

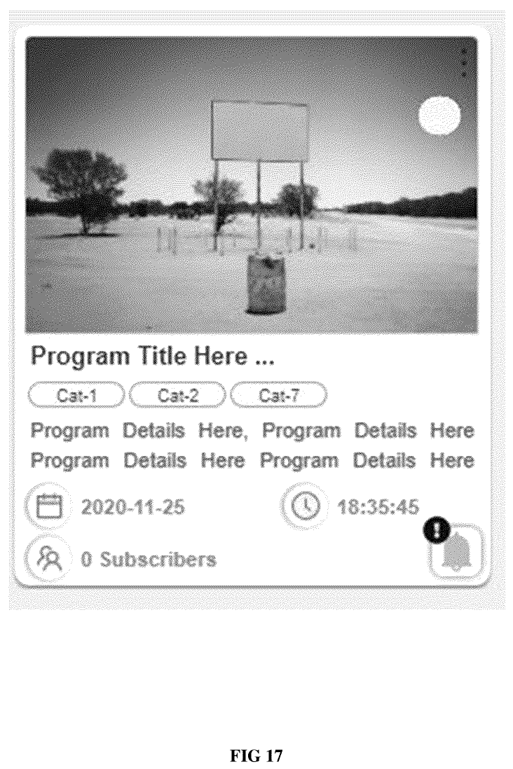

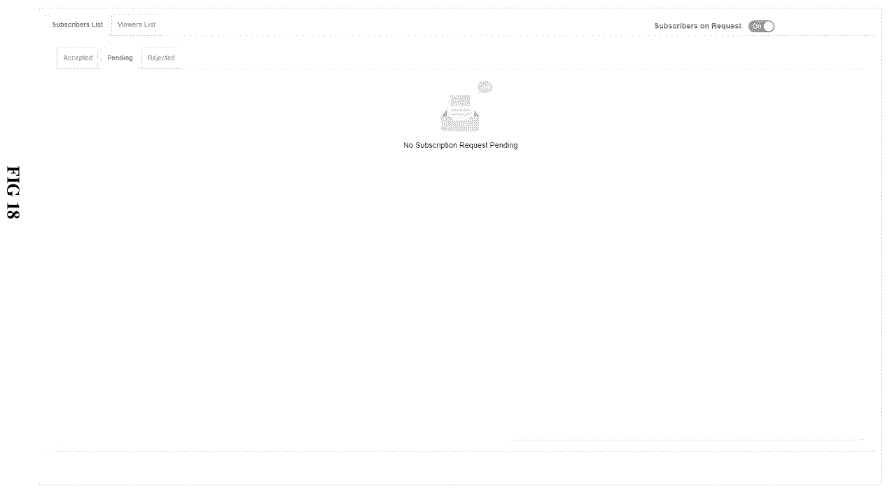

FIG. 17 shows upcoming program Card, where user needs to send access request to view scheduled program (exclamation shows Request based Access is Active)

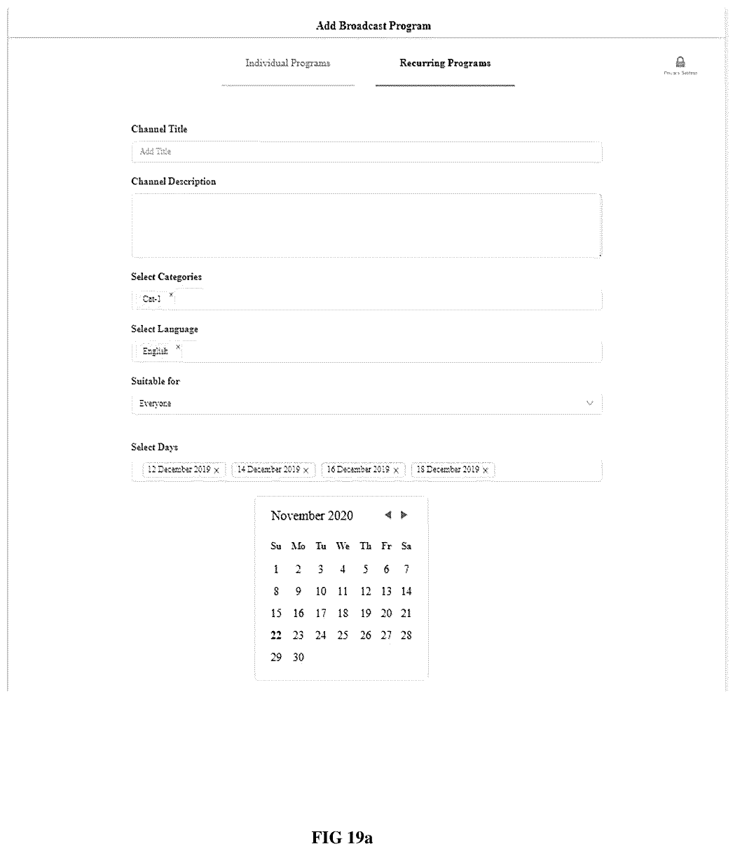

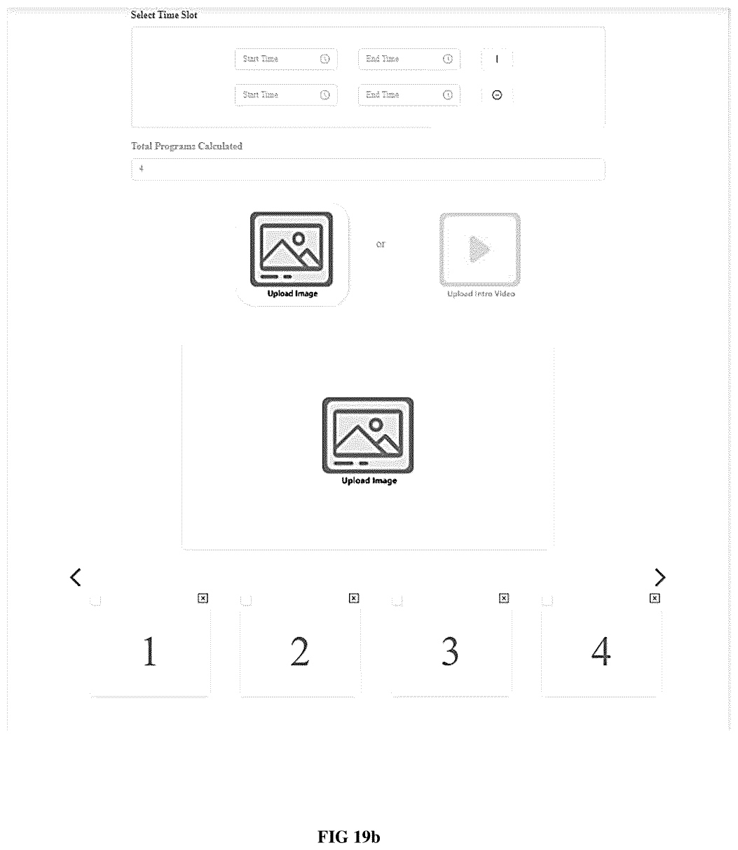

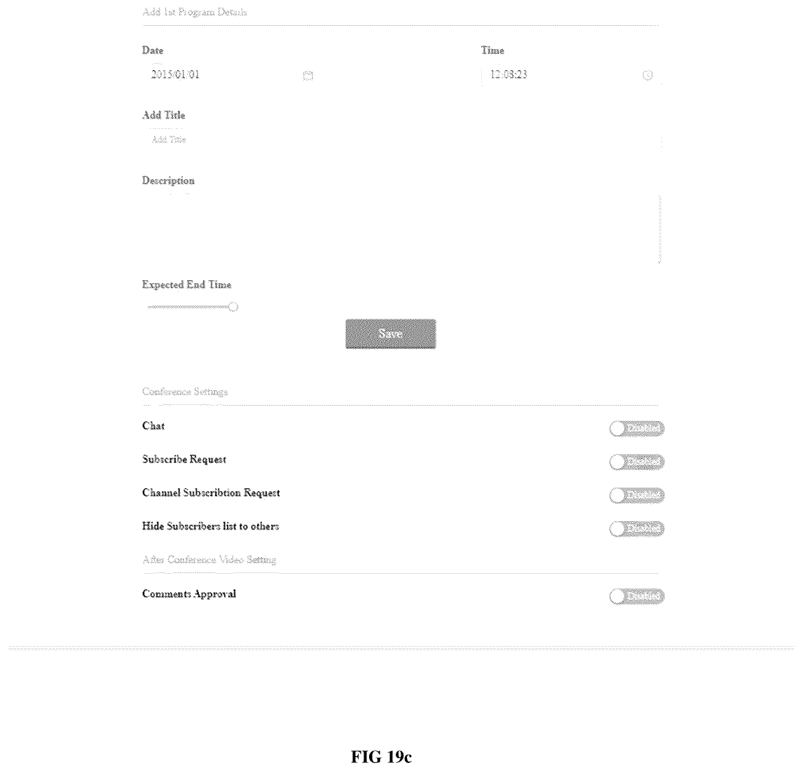

FIG. 19a, FIG. 19b, FIG. 19c shows Recurring Programs Add Form

There is also Conference recurring program add form that is where user can create multiple Future conference events and they all are related and grouped together

In propose application user will be able to schedule Broadcast Conference Program Single or Recurring,

Broadcast Conference program, Single or Recurring, Add Edit Preview Forms and UI would be similar except few add-ons, like form will have Participant field addition where conference Creator can add Potential Speakers,

Further this conference can be a private event or Public event,

In a private event only conference Presenters or Speakers can see and can participate and any such program related details will only available to them.

A private event program may be stored or not stored, If stored preferably the status of stored program will remain private, to be available any such private program publically all Participants (potential speakers) prior consent may be required. In a private event when the participants accepted the event join request, the event administrator may not be able to change status from private to public without the consent of participants (speakers) those have already accepted the request or may have to send new request for acceptance to participants again.

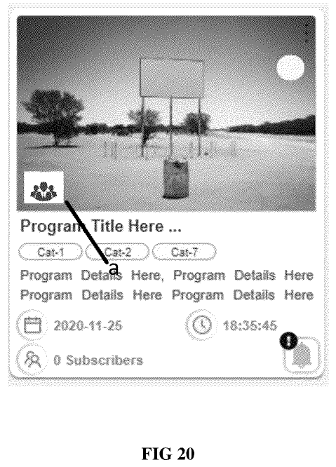

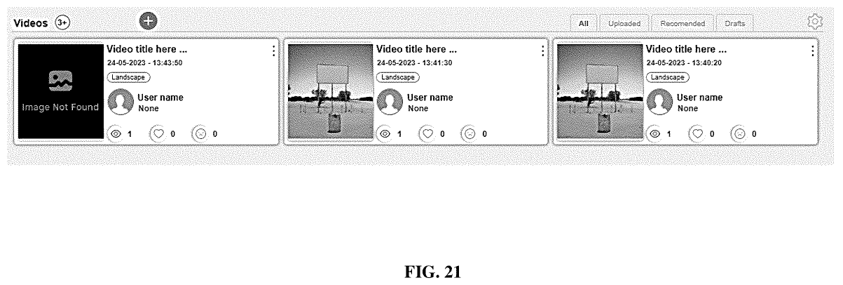

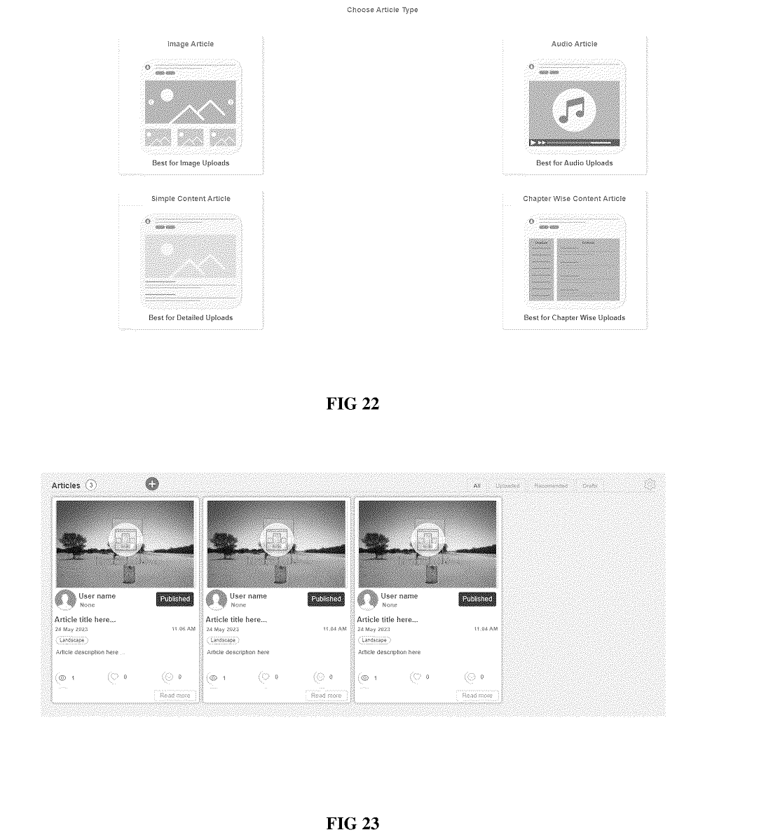

The Cards and detail pages will have add-on icon or indication shown FIG. 20 (a) and information that will show who will be the potential speakers of this event.

### In Public Event

Those who are not speakers may also be allowed to view program directly without permission or with permission, May be allowed chat, or may be allowed audio video call to participants or presenters, the conference program may be stored and allowed to be accessed again on request or without request.

For Both Programs type Broadcast and Conference, Creator/owner/Admin or authorized person can enable anti-theft mechanism to restrain user from capturing or copying program, in which viewer identifiable information is printed on the screen that will frequently change shapes and places so to discourage any act of piracy.

In proposed application User can add videos through uploading or through broadcast recording and storing

Can control access,

User may able to edit video add caption color correction or other add-ons like play default speed 1×, 2×,3× etc, which viewer can also set according to need.

User can add single video or group of videos to form a channel,

User can upload different videos to form a channel, User can Add, edit, publish, unpublished videos in channel,

User can change sequence of channel videos by selecting reshuffle function and assigning unique sequence number to videos in the channel lists.

The recurring broadcast or recurring conference videos will automatically store in sequence and will form a channel by grouping together.

Proposed application has Anti-Theft and Piracy function, most preferably for videos and streaming content, where user the owner, or authorized person can activate anti-theft or anti-piracy function, Which may discourage the viewer from unauthorized copying or regeneration of users Stored video or live stream content,

This Anti-theft or Anti-Piracy function will work as follow,

User can define for the specific video or stream anti-piracy function is enabled or applied, when enabled,

Viewer identifiable information is printed on the display screen; the information may be the viewer unique Profile ID that is of verified profile, viewer profile image, viewer current camera stream, That may change places on viewer screen and may change shapes preferably frame by frame so to discourage viewer to copy as by copying it will be very difficult for viewer to remove his/her information frame by frame that, If one viewer is allowed to view through one screen or gadget system may have automatically facial detection and recognition method which may stop stream if more than one viewer is detected.

In proposed application user can create and share article that can be Image/s based article, Single Content based article, Audio Article and Chapter based article and can Define control who can or who cannot access the article.

In proposed application user can create a question that may be answered by other user who is interested to answer apart from questioning user may answer the questions which he or she is interested in. This question can also be used as task posted, Query for quotation, which may be answered by the one interested and is able to fulfill the requirement

In proposed application user can set contact exception List, As in the application Users can contact each other, can call Audio/Video, can inbox and reply or react to each other post, Now for example if User A allows everyone to call user A but places some criteria like Age must be 20 or Above, Now one of acquaintances of user A is under 20, Who is not able to contact user A because of this criteria, So to deal this problem user A will add his/her Acquaintance in exception list where user A may mention specifically which criteria user A acquaintance has exception or All criteria based exception, After which the acquaintance can contact user A freely without any restriction.

### Appointer:

Like other services and function available to user or profile holder, User may have appointment calendar or scheduler available, where other users can make appointment with the profile user or with who the appointer is associated with, for physical or virtual meet or any other service the profile or appointment calendar owner or is related with.

Profile holder, admin or any authorized person may enable disable this function,

Can set appointment calendar or scheduler mentioning the time of availability and non-availability

Can set specific duration for every single appointment and auto continuation or cancellation of appointment session, if time limit exceeded, or adding another appointment session to already in progress appointment session.

Can set and define policy to system and available to those interested in making appointment or those who have already made appointment about cancellation procedure from both side, No show from both side, any time change from both sides,

Here owner, admin or any authorized person may set criteria that who can make appointment in which he/she may define that anyone or one with verified profile, Where he/she may mention what should be the verified profile type means, A person with simple profile verification through e-mail or mobile sms, or advance through ID documents like passport or physical verification type.

Here owner, admin or any authorized person may set criteria of appointment auto confirmation or request based confirmation, In auto confirmation the request will be automatically confirmed or may require appointer to enter code sent on mobile in set time period and when confirmed it is notified to both parties, In manual based an appointment request is made by appointer and then request is accepted, rejected or no action made, In case of accepted and rejected appointer is notified and informed the reason of rejection in case of rejected.

Here owner, admin or any authorized person can select the display type of appointment calendar In which he/she can set visible all, which shows all appointment made to other person or may select show only the available time slot, Which may only show user the available slot and not available will not be shown with the reason of no availability such as due to other reservation or appointee non availability.

Here owner, admin or any authorized person can set or enable an option of urgent appointment, where an appointment can be granted urgently on request or without request with making adjustment to already taken slots or out of working hours or in event of any other appointer cancellation.

Here owner, admin or any authorized person can set or enable a bid based appointment slots for empty slots or extra work hours slot, with defining minimum bid and when to close bid for appointment.

The appointment scheduler may be downloaded or used as offline application in pc, mobile or any of gadget which may auto or manual sync when online

Owner of appointment calendar may set control limit for appointment calendar manager/s, that what they can do and what they can't, For example only allowed to accept reject appointment request and cannot make further any changes in settings.

Here owner, admin or any authorized person can set Auto system history based approval, where system will approve or reject an appointment on the basis of appointer previous history, For example how many appointments made in past cancelled or no show ratio, if user has clean history or set number of appointment system might approve appointment automatically.

Here owner, admin or any authorized person can set appointment scheduler that may restrict person permanently from making appointment if set number of cancels or no show are reached which is calculated by system or entered by operator manually, for example user makes an appointment and cancels then system keeps record if set limit is 3 time consecutive, and 10 times aggregated, User is blocked from making appointment when he/she consecutively makes an appointment and then cancel them or makes appointment and cancel them 10 time in whole, User may contact appointment scheduler authorized person to get himself or herself removed from restricted list.

Here owner of appointment calendar May allow or delegate other user to manage appointment calendar, which may be allowed by sending request or by receiving request and a single manager may able to manage multiple appointment calendars at once

System may have control where one user is restricted from making multiple appointments at once.

Here the appointment system will work as follows,

A User A has profile and appointment scheduler set, User B wants to meet user A online or physical, user A makes appointment on user A appointment scheduler, on this appointment scheduler the appointment is automatically accepted or manually subject to appointment scheduler settings, Now when appointment is made Most preferably user B has been Assigned with some sequential number preferably that belongs to some specific period or day or a countdown number. After this sequential number or a countdown number assigned, the User B may see or notified about current appointment number in progress and User B may determine how closer or far user B appointment is, System may inform user B about the expected estimated time when user B turn is to come and system may notify user B therefore in advance when near user B appointment time is near, that user B must get ready as appointment is near to happen, The user B may be notified through sms, auto call, application notification or any other mean or method if appointment is physical meet, a notification may be generated on the basis of distance between User A and User B distance time or User B may set the system that when before to be informed through notification. Now If User B is seeking a virtual meet the system may auto dial audio or video call to user A when user B turn has come.

Now if profile appointment calendar is linked to some organization or institution the same single appointment calendar may be used for different number of users,

For Example An organization provides services, 1, 2, 3

Service 1 requires one hour to complete, Service 2 takes 2 hours to complete, Service 3 takes three hours to complete, A system is fed with the services and estimated time require to serve

Now the organization has two employees, Employee AA and Employee BB those both can provide these services, a system may be fed with services, along with time required for each service, Along with repeated sessions, along with who can serve.

Now user A makes an appointment for service 3 for first three working hours, So one of employee is now not available, But still calendar will show empty slot as another employee is still available, A user B also make an appointment for Service number 3 for first three hours, Now calendar first three hours are not available for any other user to make appointment because all available resource is reserved.

Now in this type of Organization shared appointment calendar, System may notify or may indicate to the user that who the person is, that is going to provide service or who is available to provide this service, so the appointer will have choice to make appointment or to not proceed if the server is not of his/her choice,

If appointment is for service that may require repeated sessions, the user who the appointer scheduler is associated with, may define the repeated sessions to the system along with predefined suggestive time, By making an appointment system may make auto appointment for all repeated session, or may send request to appointment scheduler for approval, Or may ask appointer that do you want to make appointment for all repeated sessions or only single event, If appointer agrees to have appointment for all repeated sessions, Then multiple appointments are made for the repeated sessions as per predefined system schedule or user may see list of all repeated sessions which the system is going to make appointment, which he may edit and then submit to have sessions appointment reserved as per his/her availability. Those repeated sessions may be cancel able and edit able.

Now issue will arise when appointer will pick random slots which may create empty slots those are not fit for some or any service or services, in this case Appointment calendar may allow appointments in such a manner so to avoid creation of useless empty slots.

Creation of recommended empty slot criteria may be defined or guided by user or is automatically managed by system.

For example if guided by User, User provides following services
Service xx takes 2 hrs
Service yy takes 3 hrs
Service zz takes 4 hrs
Now service YY is the highly in demand service user may define the system to book other appointments in such a manner that will create empty slots those can be used to book appointment for service YY

If System managed:

For example if system automatic manages function is set and user provides following services
Service xx takes 2 hrs
Service yy takes 3 hrs
Service zz takes 4 hrs

System will keep track of in demand services and on the basis of high in demand service system try to manage to create empty slots by keeping priority of services in demand.

Here User may set appointment Calendar by allocating slots specifically for specific service, for that time appointer has only choice to take only that service for which time is allocated by appointment calendar User or Admin.

Appointment Calendar as enroller:

In this application, Similar to appointment calendar a user may have an enroller if user does some sort of coaching or teaching,

User may set subject matter he or she is expert in and available to coach or guide, the enroller can be set for two types,

One collective and another individual

Individual enroller is similar to appointment calendar where individual can enroll for some specific time slot that may be allowed by coach/enroller/profile owner and any other authorized person, But the major difference between an enroller and appointment calendar would be, that time slot reserved will be reserved automatically for other days if enroller has mentioned some minimum time period enrollment for individual.

Let's suppose User A is Coach he sets enroller where he mentions that he is available for 30 days a month between 6:00 pm to 8:00 pm to coach English Individually,

The minimum slot reserve is for 1 hour,

Now user B is interested and when user B reserved that slot, the reservation is made for complete one month automatically and user B does not have to make reservation individually for each single day.

In collective user may set slot and can mention the recurrence of the event and the event type for the slot is reserved and the number of candidates maximally can enroll and the progress of the coach class like it is to begin in future or is ongoing etc. by mentioning that these numbers of candidates can enroll to this program, which may show the status of exact vacancy or only vacancy to potential candidates. For example if enroller allows 20 enrollments for particular program and currently 15 has been made, System may show the exact left 5 enrollments to potential candidate or just show that still enrollment is available, subject to display settings made by enroller. This enroller Tab/Button or link may be displayed on Coach or related profile or may be displayed on programs single or recurring type.

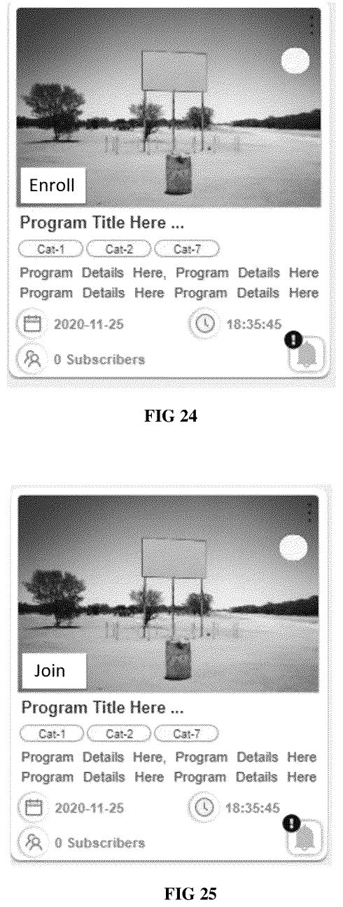

FIG. 24 Shows Enrolling option on scheduled program card.

### Event Management:

The application can also be used for Event based Exhibition, Or a digital Presentation, conference, Opera, concert etc.

Where in application the authorized user the event organizer can create event and can define the seating plan, where he/she can mention the number of Seats physical available with number of seats virtually available for participants. Here the authorized person the event organizer may mention criteria to the application that the participant must meet in order to reserve his/her seat for physical participation or virtual participation in the event.

The event created GUI may be similar to single or Recurring Program with few add-ons,

System may update the seat availability status in real time,

Event management may allow direct reserve or request based reservation,

In direct Reserve anyone meeting the criteria defined by organizer in application can directly reserve the seat in the event,

In request based, any-one meeting the criteria can send request to reserve seat to event organizer or authorized person, which may be accepted or rejected by event organizer, which may be notified to request sender through notification

In case of event cancellation or delayed or any changes, Participants with reserved seats may be notified for changes through notification.

Now to avoid unlawful copying and distribution of Stream by Virtual Participant, Event organizer or authorized person may apply or enable anti-theft or piracy function (the function already mentioned).

### Contest:

Like other functions in this application, the user will have the function of creating a contest. The contest may be public or private. Privately, only allowed users may view and participate, and may also input data or feedback, the organizer may pre-provide access to those who may engage or view particular competition. In public contest, other users may also view, participate in the contest, who meets the criteria defined by the organizer. The pubic contest event can be request-based, where those who want to participate or watch can send a request to the organizer or user to access the event. The organizer can specify the criteria for participation. Where he can mention the date and time of the start and end of the contest, which will be similar to the creation of a future event and can use a similar graphical interface as a function of the program with minor changes.

In this function of the contest, the organizer can mention what is required of the participants to submit, for example,
Video clip with time duration
Audio clip with time duration
Image only
Or some kind of text response

How many applications from one participant are allowed and whether the submission is editable by the applicant after submitting the application.

The organizer may be allowed to delete submission if it is inappropriate or may require to set minimum inappropriate actions to delete that view to discourage bias, as if only the organizer could do it, s/he can manipulate. For example, during the creation of the event, the organizer mentioned that any inappropriate submission will be deleted, but at least 10 inappropriate report actions from other users are required, it is most preferable that this particular criterion is not edited after. And after 10 reports of improper application submission, the organizer can delete inappropriate submission then.

If contest is based on the reward, organizer may determine and mention the reward and the minimum reward qualification criteria. For example, if the organizer creates a competition, s/he may mention, that the reward will be distributed only if, Set minimum criteria is met by participant, like

Minimum number of votes for best participants or winners are met,

Now, the organizer may create a competitive event which may begin if the minimum criteria of interest is met or reward contribution is met, where other users show support for that contest within a given time, else contest event is removed or will be closed by the application

An organizer may create a pool reward based contest, where other users can add rewards for the participants, those adding rewards may be added to organizer list or may not be displayed as organizers, Subject to event policy or contributor willingness

Any reward allocated for contest may be reserved and locked by the application that is not withdraw able by the organizers but only if defined criteria in application is met where withdrawal is possible, If withdrawal criteria for pool event are met, only poolers can make withdrawal as per their contribution

The contest function is planned to work as follow

Organizer creates a contest Event that is going to happen in future, People showed the support and event is not delisted, Now organizer has mentioned the detailed criteria for participation,

Like, contestant need to upload 5 minutes video about some topic,

When participant submit that video, the video is added in the list ordering videos for latest to oldest, where people can watch and vote,

Along with submission list, Another Top participant list is maintained and compiled by the application that is updated most preferably in real time that is ordering the participants those are top by vote which may have filters such as top list of all time, Top list of One day etc.,

When the event is closed as its time reaches to an end the system will automatically announce the top list and distribute rewards as predefined by organizer

An event can be request based where the viewer of contest may send request access to organizer to view the contest event, That may be sent in before, During or after the event and organizer may accept reject or

Take no action on request, In case organizer takes any action, the system may notify the sender of request in timely manner.

Most of the functions defined in this application may be used in whole or in part with each other.

I claim:

1-5. (canceled)

6: A Multi-user interactive platform application according to claim 28, characterized in that in the proposed application, the user can configure and assign any other person or persons, for application based audio video call to be forwarded if the user is already busy or unavailable, while the caller can see in advance a list of those to whom the call will be forwarded, or the system can provide the opportunity to choose to whom the call should be forwarded, where the caller can choose which redirector the caller wants to talk to or who the call should be forwarded to, and the caller can decide within a certain period or without limitation to continue or cancel the call.

7-8. (canceled)

9: A Multi-user interactive platform application according to claim 28, characterized in that when the user is an important person and has several subscribers calling at the same time in application, the caller has the opportunity to continue by deciding to keep himself in the caller queue, while if the caller wants to continue, the caller can select the automatic dialing function in which the system can assign a queue number to the caller, which will preferably be an sequential number with countdown number, while in the countdown it is most preferable when the number 0 is reached, this means, that it is now the caller's turn and the call is automatically dialed by the system, and then the user answers, while the automatic dialing function will keep the caller in the queue, and when the caller's number reaches, it will automatically dial the call, when the automatic dialing function is selected, the system can continue to inform the current number in the process, most preferably displayed on the screen of the waiting calling device or application, at the same time, the system can also tell the caller the estimated waiting time and stay when the caller's is still waiting in queue, this queue number can also be a countdown down, if the caller's queue in the queue is far away, the caller can choose a notification based on a hint, so instead of sticking to the application, the caller can perform other tasks, the user can direct the system to send a notification before the set estimated time before the caller's call is dialed, or it can choose to generate a notification when a certain queue number is reached.

10: A Multi-user interactive platform application according to claim 28, characterized in that if there are some privileged call criteria set by the user in the system application, the caller will be able to make a priority call rather than waiting in the queue, if the caller is a privileged subscriber and meets the criteria of a privileged caller, then the caller will have priority on others those do not meet the privileged criteria, added by the user in the system, at the same time, the user may be able to set the time for automatic termination of incoming calls, for example, the user has set the maximum call limit to 5 minutes, each incoming call will be automatically terminated after 5 minutes or another meeting session will be added to an existing meeting session, which may or may not be notified to the caller in advance during or at the end of the call.

11. (canceled)

12: A multi-user interactive platform application according to claim 28, characterized in that the user can use identity less chat and inbox functionality in real time, where user or users can enter into identity less chat when online in real time, when the mode is activated or started that will remove any name image or identity of users in conversation interface from application view. Preferably this identity less chat will vanish once conversation ended instead of stored at user's end, this identity less chat can be initiated during the chat session or before the chat session started. This identity less session may require consent of all participant to initiate session. When identity less chat is initiated system may assign dummy identities to users to keep their conversation track.

13-14. (canceled)

15: A multi-user interactive platform application according to claim 28, characterized in that it provides a broadcast chat that is broadcasted, where those who are not part of the chat can see the conversation in the chat, if allowed, the purpose of this type of chat is to facilitate direct audio/video transmission, while here the one that who is the broadcaster or its authorized or designated person can enable disable the chat, can control who can do the chat, and can additionally activate the preview function based on moderation. At the same time, in the preview function based on moderation, the broadcast chat is not published unless it is approved by the moderator of the broadcast, which can be a person or a machine, if a person, the broadcaster can appoint a moderator or moderators of the chat during the creation of the broadcast event where the request is sent to a potential moderator/s to accept the task of moderation, where the recipient of the request can accept or reject this request to be a moderator., at the same time, if accepted, during the broadcast, only the broadcaster and the designated moderator will receive the chat first, that is, an unpublished one that they can allow to publish or reject to remove from the queue of other chat, while here the moderator or the broadcaster can mark some chatter as a direct publication, in which the system will directly publish the chat of those, those who are marked or allowed by direct publication for the current session or for the future, and the marked allowed can be removed, while participants can be allowed to attach a file, and the broadcaster, moderator or any designated person can allow or prohibit the file type or any attachment, wherein broadcaster or moderator or any of assigned person may control file download ability on other participants or may only is downloaded or if media type file played on broadcaster to be viewed by others.

16-27. (canceled)

28: A multi-user interactive platform application is a full-fledged software platform application in which the user can create his/her profile, wherein while creating profile user can select type of profile that belongs to natural person or to institution or organization, where if institution or organization type is selected the profile display name must be unique, where if institution or organization is selected and subject to category or industry type the profile template and functionality will differ from one another, where if individual or organization is selected user may be able to access limited services prior to profile verification that may require different level of verification subject to profile category type. At the time of signing up underage user will be required to get prior guardian approval, guardian must be another application user, to use the application. After successful registration to application, user may be able create, add, edit, share and publish content such as programs, videos, articles, tasks, assignment, questions, list of services, video streams, can interact with other users by various means, can create events, can set programs enroller, can set contest, can access and set appointment system, can protect his/her content from unauthorized copying and distribution, establish content and contact access controls.

29: A multi-user interactive platform application of claim 28, further comprising, wherein user can schedule upcoming live broadcast program by selecting category type of upcoming broadcast.

30: A multi-user interactive platform application of claim 28, further comprising, wherein on scheduling live broadcast program the allowed followers, those are connected to user creating program profile are notified about upcoming scheduled broadcast programs created by followed user

31: A multi-user interactive platform application of claim 28, further comprising, only upcoming scheduled live broadcast program subscribers are notified of any subsequent updates related to scheduled live broadcast program, such as program date time change, such as program cancellation, such as program happening reminder.

32: A multi-user interactive platform application of claim 28, further comprising, where user can schedule open and request access based upcoming live broadcast program

33: A multi-user interactive platform application of claim 28, further comprising, where for upcoming broadcast programs, user can decide and set criteria for access based request automatic management system or select Manual approval system, In auto access based request approval system, to access upcoming broadcast programs, request is accepted, if set criteria is met and is rejected if criteria is not met by potential viewer the request sender.

34: A multi-user interactive platform application of claim 28, further comprising, where user can schedule group based multiple upcoming recurring broadcast programs

35: A multi-user interactive platform application of claim 28, further comprising, where Allowed user can see progress and status of scheduled single and grouped recurring upcoming broadcast programs, such as, which will be in the future, will start next week, are at the initial stage or at the completion stage for example if there are group of 10 live broadcasts system may show progress that 8 are upcoming 1 is past and one currently in progress or 40% completed and 60% remaining with a countdown method for upcoming scheduled live broadcast

36: A multi-user interactive platform application of claim 28, further comprising, where allowed user can send request to access, single or recurring grouped broadcast program during any stage of program

37: A multi-user interactive platform application of claim 28, further comprising, where user can also schedule, multiple presenter based upcoming conference broadcast program/s

38: A multi-user interactive platform application of claim 28, further comprising, where user can schedule private and public, single and recurring, multiple presenter based upcoming broadcast conference programs.

39: A multi-user interactive platform application of claim 28, further comprising, where broadcast conference program organizer may need permission of all presenters to change status of broadcast conference program from private to public and public to private

40: A multi-user interactive platform application of claim 28, further comprising, where user can activate anti-theft and anti-piracy function to counter his/her, video, broadcast, video call type content unauthorized copying and distribution. When anti-piracy and anti-theft function is activated, viewer identifiable information is printed on the display screen such as, the information may be the viewer unique Profile ID that is of verified profile, viewer profile image, viewer current camera stream or any other identifiable information, That may change places on viewer screen and may change shapes preferably frame by frame so to discourage viewer to copy as by copying it will be very difficult for viewer to remove his/her information frame by frame

41: A multi-user interactive platform application of claim 28, further comprising, where individual or institution profile functionality will vary subject to profile type and category and level of verification required.

42: A multi-user interactive platform application of claim 28, further comprising, where user, the contacted person, can set the level of verification of profile the contacting person must have to contact user through inbox, audio, video call.

43: A multi-user interactive platform application according to claim 28, characterized in that when creating a profile, the user is assigned a unique code for each profile, while the unique code can be used as an incoming call number, where this code can be entered after making a call to application universal number/s that redirects the call to the user to the contact number specified by him in application or directly this unique code can be dialed together with application provided universal number/s. Contact number provided by user to application is not public and is only know to application.

44: A multi-user interactive platform application wherein user can set contact package/s comprising total number of messages and number of audio video calls that package holder can make along with term of package/s.

45: A multi-user interactive platform application of claim 44, further comprising, where user can set exclusion list of users those can directly contact user even though they don't own contact package/s and are not meeting any contact based criteria defined by user.

46: A multi-user interactive platform application according to claim 28, characterized in that in the proposed application Caller will have option of Pool calling, Pool calling is the incoming call with one recipient and multiple callers at once, Once means all in one session, Pool calling may be planned or unplanned, When pool calling is unplanned caller may add other participant that may require user permission who call is being made, In planed pool calling, caller can create a pool calling event with future date and time of call with adding other callers and User who is to be called that can be accepted or rejected by other callers and User if they want, If there is any criteria set by User for such incoming call, callers must meet that criterion to create such pool calling event that includes the User, who is going to be called, A User may receive a request for this pool calling event scheduled to have incoming call to user which may be accepted, rejected or No action made by User Who call is to be made, System may auto cancel request if not responded by User within some specific time period, If accepted system may auto dial call at the set event time, A caller may edit or delete such calling event subject to policy defined and accepted by User who is going to be called; System may send user an updated request for acceptance, rejection or no action.

47: A multi-user interactive platform application of claim 28, further comprising, where user, owner, admin or authorized person, can set criteria in appointment calendar that who can make appointment in which he/she may define that anyone or one with verified profile, Where he/she may mention what should be the verified profile type, here user can set or enable a bid based appointment slots for empty slots or extra work hours slot, with defining minimum bid and when to close bid for appointment. Here user can set Auto system history based approval, where system will approve or reject an appointment on the basis of appointer previous history, For example how many appointments made in past cancelled or no show ratio, if user has clean history or set number of appointment system might approve appointment automatically. Here owner, admin or any authorized person can set appointment scheduler that may restrict person permanently from making appointment if set number of cancels or no show are reached which is calculated by system or entered by operator manually, System may have control where one user is restricted from making multiple appointments at once for the same time, If appointment is for service that may require repeated sessions, the user who the appointer scheduler is associated with, may define the repeated sessions to the system along with predefined suggestive time, By making an appointment system may make auto appointment for all repeated session, or may send request to appointment scheduler for approval, Or may ask appointer that do you want to make appointment for all repeated sessions or only single event, If appointer agrees to have appointment for all repeated sessions, Then multiple appointments are made for the repeated sessions as per predefined system schedule or user may see list of all repeated sessions which the system is going to make appointment, which he may edit and then submit to have sessions appointment reserved as per his/her availability. Those repeated sessions may be cancel able and edit able.

48: multi-user interactive platform application of claim 28, further comprising, where user can enable enroll function on single event based or multiple event based, single presenter based or multiple presenter based, upcoming broadcast program/s

49: A multi-user interactive platform application of claim 28, further comprising, where user can schedule single event based or multiple event base, single presenter based or multiple presenter based physical and online accessible upcoming program event. Where in application the authorized user the event organizer can create event and can define the seating plan, where he/she can mention the number of Seats physical available with number of seats virtually available for participants. Here the authorized person the event organizer may mention criteria to the application that the participant must meet in order to reserve his/her seat for physical participation or virtual participation in the event.
the event created GUI may be similar to single or Recurring Program with few add-ons, System may update the seat availability status in real time, Event management may allow direct reserve or request based reservation, In direct Reserve anyone meeting the criteria defined by organizer in application can directly reserve the seat in the event, In request based, any-one meeting the criteria can send request to reserve seat to event organizer or authorized person, which may be accepted or rejected by event organizer, which may be notified to request sender through notification In case of event cancellation or delayed or any changes, Participants with reserved seats may be notified for changes through notification.
